(19) United States
(12) Patent Application Publication
(10) Pub. No.: US 2025/0386278 A1
(43) Pub. Date: Dec. 18, 2025

(54) SYSTEMS AND METHODS FOR CONNECTING INTERNET SERVICE PROVIDERS TO A SATELLITE COMMUNICATIONS NETWORK

(71) Applicant: Space Exploration Technologies Corp., Hawthorne, CA (US)

(72) Inventors: Robert Wiggenhorn, Seattle, WA (US); Nicholas Mirchandani, Redmond, WA (US); Patrick Lawless, Lake Stevens, WA (US); Scott Fukushima, Renton, WA (US)

(21) Appl. No.: 19/225,397

(22) Filed: Jun. 2, 2025

Related U.S. Application Data
(60) Provisional application No. 63/659,772, filed on Jun. 13, 2024.

(51) Int. Cl. H04W 40/12; H04W 24/04; H04W 24/08; H04W 40/24; H04W 84/06; H04W 88/16

(52) U.S. Cl. CPC H04W 40/12; H04W 24/04; H04W 24/08; H04W 40/246; H04W 84/06; H04W 88/16

(57) ABSTRACT

A community gateway for a satellite communication system can include a network switch configured to route data packets received from an Internet Service Provider (ISP); and a plurality of community gateway (CGW) antennas. The satellite communication system includes terrestrial gateway terminals in communication with the Internet. Each CGW antenna is configured to communicate with the satellites via a CGW-SAT link, and each CGW antenna includes a network interface processor configured to route data packets between the network switch and the CGW antenna. The network interface processor is configured to report to the network switch a connection status of a connection between the CGW antenna and a node of the satellite communication system. The network switch is configured to route the data packets to the CGW antennas for transmission through the satellite communication system based on the reported connection status of the CGW antennas.

### TECHNICAL FIELD

The present technology pertains to network communication paths utilizing satellites and more specifically to connecting Internet Service Providers (ISPs) to a satellite communications network.

### BACKGROUND

Satellite communication systems can provide Internet access to user terminals at user terminal locations, for example at homes or businesses. The satellite in this context can receive, from a user terminal, a request for data, such as a web page the user desires to view or a video a user desires to watch by way of non-limiting examples. The user will typically be at a user device which can be a computing device such as a computer or a mobile device. The user device gains access to the Internet via the user terminal and its connection to the satellite. The satellite in turn will transmit signals to a ground station (called a gateway terminal) on Earth with the request to obtain the data. The gateway terminal is connected to a point-of-presence (PoP) on the Internet or another ground-based network or data storage device that stores the requested data. The satellite and the gateway terminal transmit and receive signals via a respective satellite gateway-wavelength antenna and a gateway terminal antenna. The gateway terminal will access the Internet or other network to obtain the desired data and to transmit the data up to the satellite. The satellite then transmits the data down to the user terminal using a user terminal-wavelength antenna, such that the user can access the data on a user device.

However, in some locations without traditional Internet access, it may not be feasible or affordable for every prospective individual user to purchase and install a user terminal, or for a business, school, or other institution to install and manage a sufficient number of user terminals to support all of its employees or students, for example. In such cases, prospective individual users or institutions may prefer to connect through a traditional Internet Service Provider (ISP) model, in which the ISP is a separate intermediary entity responsible for maintaining a high-throughput link to the Internet, and for providing and managing Internet access through that link to individual users and institutions. It would be beneficial to enable the ISP to use a satellite communications system to implement such a high-throughput link to the Internet.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

This disclosure provides a new approach to enable Internet Service Providers (ISPs) to implement a high-throughput link to the Internet via a satellite communication system. Rather than relying on traditional user terminals of the satellite communication network, which are typically each sized and configured to handle Internet traffic for a limited number of users, such as a single household, the present disclosure provides a “community gateway,” that is, a dedicated collection of high-throughput gateway terminal antennas dedicated for backhaul use by the ISP.

In order to avoid conflicts caused by the use of the satellite's gateway-wavelength antenna for communicating with both the community gateway and the conventional gateway terminal, the satellites of the satellite communication network can implement direct inter-satellite communication to form a satellite mesh topology, independent of the gateway-wavelength antenna. Accordingly, when a first one of the satellites is using its gateway-wavelength antenna to communicate with the community gateway, the first satellite can route communications to and from the ground through the satellite mesh topology to the gateway-wavelength antenna of a second satellite, enabling simultaneous communication with the Internet via a conventional gateway terminal to which the second satellite is connected.

The multiple gateway terminal antennas of the community gateway can be used to reduce a downtime of the high-throughput link. More specifically, high-throughput gateway terminal antennas include parabolic dishes that must mechanically track satellites in low-Earth orbit (LEO) as the satellites successively cross the sky over the antenna site. After every satellite pass, the gateway terminal antenna must mechanically slew back to acquire another satellite. As a result, an individual gateway terminal antenna typically can experience approximately five to fifteen percent downtime in its communication with LEO satellites over the course of, for example, an hour. Multiple gateway terminal antennas can cooperate to provide a connection with a more acceptable downtime, but this cooperation conventionally requires sophisticated software and communication links between the controllers of the multiple gateway antennas, which can increase a complexity and cost of manufacture, installation, and maintenance, particularly in a remote location. Some embodiments of the present disclosure can avoid this problem by leveraging commercial off-the-shelf capabilities of a network switch at the community gateway site in a novel fashion to detect when rollover of the ISP connection within the community gateway from one gateway terminal antenna to the next is required to avoid downtime in the high-throughput link.

In accordance with an embodiment of the present disclosure, a community gateway for a satellite communication system is provided. The satellite communication system includes a plurality of terrestrial gateway terminals and a plurality of satellites, wherein the terrestrial gateway terminals are in communication with the Internet, and wherein each of the satellites includes a satellite (SAT) gateway-wavelength antenna. The community gateway can include a network switch configured to route data packets received from an Internet Service Provider (ISP); and a plurality of community gateway (CGW) antennas, wherein each CGW antenna is configured to communicate with the SAT gateway-wavelength antenna via a CGW-SAT link, and wherein each CGW antenna includes a network interface processor configured to route data packets between the network switch and the CGW antenna. The network interface processor includes a network interface processor memory storing instructions executable to cause the network interface processor to perform network interface steps that can include reporting to the network switch a connection status of a connection between the CGW antenna and a node of the satellite communication system. The network switch includes a network switch memory storing instructions executable to cause the network switch to perform network switch steps that can include routing the data packets to the CGW antennas for transmission through the satellite communication system based on the reported connection status of the CGW antennas.

In accordance with another embodiment of the present disclosure, a method of operating a community gateway for a satellite communication system is provided. The satellite communication system includes a plurality of terrestrial gateway terminals and a plurality of satellites, wherein the terrestrial gateway terminals are in communication with the Internet, wherein each of the satellites includes a satellite (SAT) gateway-wavelength antenna, wherein the community gateway includes a network switch and a plurality of community gateway (CGW) antennas, wherein the network switch is configured to route data packets received from an Internet Service Provider (ISP), wherein each CGW antenna is configured to communicate with the SAT gateway-wavelength antenna via a CGW-SAT link, and wherein each CGW antenna includes a network interface processor configured to route data packets between the network switch and the CGW antenna. The method includes steps that can include one or more of: reporting, by the network interface processor to the network switch, a connection status of a connection between the CGW antenna and a node of the satellite communication system; and routing, by the network switch, the data packets to the CGW antennas for transmission through the satellite communication system based on the reported connection status of the CGW antennas.

### BRIEF DESCRIPTION OF THE DRAWINGS

In order to describe the manner in which the above-recited issues can be addressed, a more particular description of the principles briefly described above will be rendered by reference to specific embodiments thereof that are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1A illustrates a simplified schematic of an exemplary satellite communication system, including a community gateway, in accordance with embodiments of the present disclosure;

FIG. 1B illustrates a simplified block diagram of the satellite communication system of FIG. 1A in accordance with embodiments of the present disclosure;

FIG. 2 is a schematic showing exemplary planar orbital patterns of a group of satellites, which may be used in the satellite communication system of FIG. 1A, around a rotating Earth in accordance with embodiments of the present disclosure;

FIG. 3 illustrates a not-to-scale aerial view of an exemplary ground area that may be serviced by the satellite communication system of FIG. 1A, including user terminals grouped into service cells, the community gateway, and gateway terminals;

FIG. 4 illustrates a not-to-scale aerial view of the ground area shown in FIG. 3 being serviced by certain exemplary satellites of the group in communication with the user terminals, the community gateway, and the gateway terminals;

FIG. 5 illustrates a simplified block diagram of example elements of the community gateway shown in FIG. 1A in combination with the satellite communication system shown in FIG. 1A, in accordance with embodiments of the present disclosure;

FIG. 6 illustrates an example data flow between an Internet Service Provider (ISP) and the satellite communication system shown in FIG. 1B via the elements of the community gateway shown in FIG. 5, in accordance with embodiments of the present disclosure;

FIG. 7 illustrates an example method in accordance with embodiments of the present disclosure; and

FIG. 8 illustrates a computer system that can be implemented with other aspects of the present disclosure.

### DESCRIPTION OF EXAMPLE EMBODIMENTS

Various example embodiments of the disclosure are discussed in detail below. While specific implementations are discussed, it should be understood that this description is for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment. Such references mean at least one of the example embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative example embodiments mutually exclusive of other example embodiments. Moreover, various features are described which may be exhibited by some example embodiments and not by others. Any feature of one example can be integrated with or used with any other feature of any other example.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various example embodiments given in this specification.

Without intent to limit the scope of the disclosure, examples of instruments, apparatus, methods and their related results according to the example embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

For clarity of explanation, in some instances the present technology may be presented as including individual functional blocks representing devices, device components, steps or routines in a method embodied in software, or combinations of hardware and software.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, it may not be included or may be combined with other features.

As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term).

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

### Elements of a Satellite Communication System

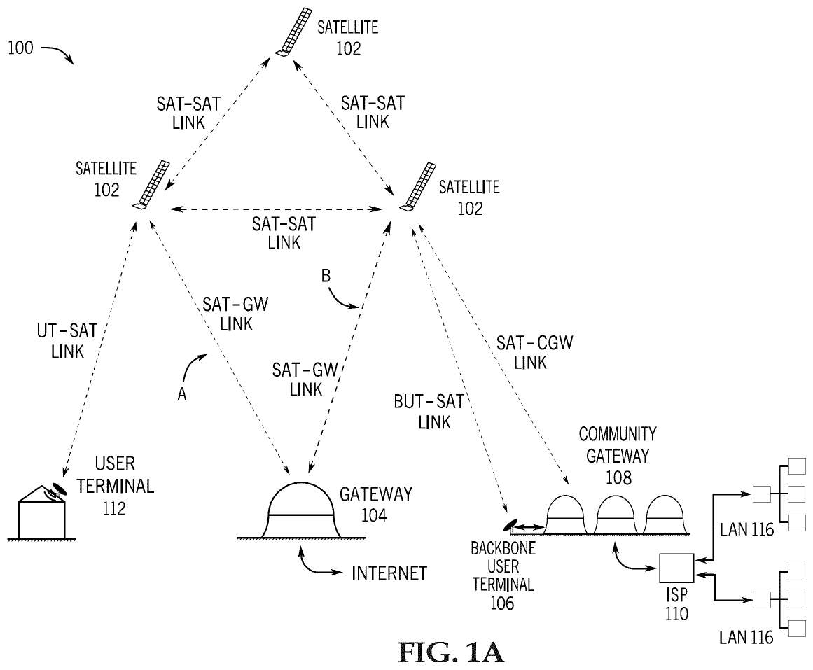

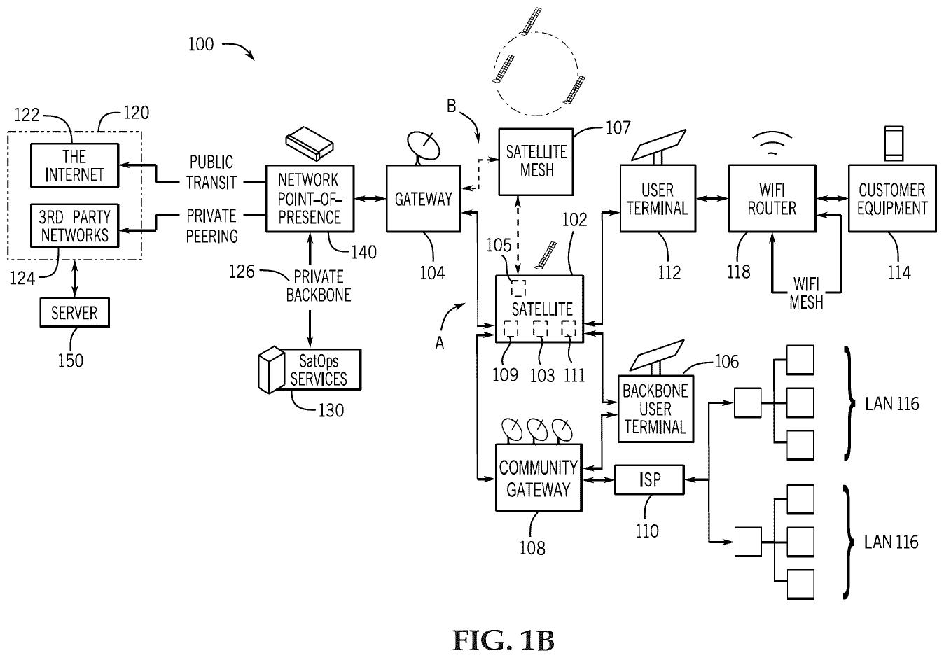

FIG. 1A is a simplified schematic, and FIG. 1B is a simplified block diagram, of elements of an exemplary satellite communication system 100. The elements are capable of communication with each other via a mesh topology. The term “mesh topology” refers to the configuration of the elements as nodes in a mesh network. The various nodes in the mesh network coordinate with one another to efficiently route data in order to respond to requests for user data. As will be discussed in more detail herein, the configuration of the nodes in the mesh topology changes dynamically in satellite communication system 100 to account for factors such as the motion of the satellites 102 relative to the Earth's surface and, in some cases, relative motion among the satellites 102. For example, as part of the network mesh topology of the satellite communication system 100, certain satellites 102 may communicate directly with each other in a satellite mesh topology 107.

In addition to the satellites 102, the satellite communication system 100 also includes a gateway terminal 104 on Earth and a community gateway 108 on Earth. The satellite communication system 100 also typically includes a user terminal 112 on Earth, although embodiments without the user terminal 112 are also contemplated. The user terminal 112, the gateway terminal 104, and the community gateway 108 may be referred to collectively as “ground terminals.” Each satellite 102 includes an onboard satellite computer system 103 programmed to manage communications with user terminals 112, gateway terminals 104, community gateways 108, and other satellites 102, using one or more communication terminals (e.g., RF antennas and/or laser communication terminals) of the satellite. In particular, the satellite computer system 103 routes communications to and from those nodes through the respective satellite 102 as part of the network mesh topology.

User terminal 112 may be installed at a house, a business, a vehicle (e.g., a land-, air-, or sea-based) vehicle, or another Earth-based location where a user desires to obtain communication access or Internet access via the satellites 102. An Earth-based user terminal 112 may be a mobile or non-mobile terminal connected to Earth or as a non-orbiting body positioned near Earth. For example, an Earth-based user terminal 112 may be in Earth's troposphere, such as within about 10 kilometers (about 6.2 miles) of the Earth's surface, and/or within the Earth's stratosphere, such as within about 50 kilometers (about 31 miles) of the Earth's surface, for example on a stationary object, such as a balloon, or a mobile object, such as an automobile or an airplane.

For example, the user may connect one or more network devices 114 such as desktop computers, laptops, mobile devices, Internet of Things (IoT)-enabled devices, and the like (collectively, “customer equipment”) locally to the user's user terminal 112 and obtain access via satellites 102 to the Internet. Although the local connection between the customer equipment and the user terminal is illustrated as a WiFi router 118 (or more broadly a WiFi mesh), other types of wired or wireless local communication are also contemplated.

The gateway terminal 104 serves as a satellite access gateway for the satellite(s) 102 to communicate with one or more ground-based networks 120, such as the Internet 122 or another ground-based network 124. For example, the “other” type of ground-based network 124 may represent a limited access third-party network, such as but not limited to a cloud computing data center. The gateway terminal 104 may be connected to a point-of-presence (PoP) 140 on the ground-based network 120. For example, a dedicated PoP 140 may be assigned to each gateway terminal 104, and may be physically wired to the gateway terminal 104. In some cases, multiple gateway terminals 104 at a same site can be connected to a same PoP 140. Additionally or alternatively, different gateway terminals 104 at a same site can be connected to different PoPs 140. The PoP 140 may access data from the ground-based network 120 (e.g., from one or more servers 150) and provide the data back through the satellite communication system 100 to the user terminal 112 and network device 114.

The community gateway 108 provides an alternative to the user terminal 112 for institutions or individuals that may prefer to connect through a traditional Internet Service Provider (ISP) 110. The ISP 110 can be a separate intermediary entity responsible for maintaining a high-throughput link to the Internet 122, and for providing and managing Internet access through that link to individual users and institutions. The ISP 110 can use the community gateway 108 to provide backhaul for users on one or more local area networks (LANs) 116 serviced by the ISP 110.

The illustrated communication signal paths in the satellite communication system 100 include a link between the user terminal 112 and one of the satellites 102 in the mesh, which may be referred to as a UT-SAT link. For example, each of the satellites 102 can include a phased array antenna 111 for transmitting and receiving directional RF signals, and the user terminal 112 can likewise include a phased array antenna (not shown) for transmitting and receiving directional RF signals in the Ku band. In the exemplary embodiment, the UT-SAT link is implemented as a Ku-band radio frequency (RF) link, and the phased array antenna 111 is configured for transmitting and receiving RF signals in the Ku band. However, other types of communication links are also contemplated for implementing the UT-SAT link, for example, other bands or other types of links including optical links. Moreover, while only one user terminal 112 and three satellites 102 are illustrated, satellite communication system 100 may include millions of user terminals 112 and many thousands of satellites 102, and different ones of the user terminals 112 and satellites 102 may use different types of communication links to establish the UT-SAT link.

The illustrated communication signal paths in the satellite communication system 100 also include a link between one of the satellites 102 in the mesh and the gateway terminal 104, which may be referred to as a SAT-GW link. For example, each of the satellites 102 can include a gateway-wavelength antenna 109, and the gateway terminal 104 can also include a gateway-wavelength antenna configured to communicate with the satellite's gateway-wavelength antenna 109. In the exemplary embodiment, the SAT-GW link is implemented as a Ka-band or E-band radio frequency (RF) link, and the gateway-wavelength antenna 109 is a parabolic antenna for transmitting and receiving RF signals in the Ka band, the E band and, or both. However, other types of communication links are also contemplated for implementing the SAT-GW link. For example, the satellites 102 may also include laser communication terminals 105, as described below, that can provide a dual function by serving as the gateway-wavelength antenna 109, and the gateway terminal 104 may also include one or more laser communication terminals for communication with the satellites 102 when atmospheric weather conditions are favorable for ground-to-space (and space-to-ground) laser transmission. It should be understood that the gateway terminals 104 can include multiple antennas in any combination of parabolic antennas, laser communication terminals, or other type of communication links. Moreover, while only one gateway terminal 104 and three satellites 102 are illustrated, satellite communication system 100 may include hundreds of gateway terminals 104 and many thousands of satellites 102, and different ones of the gateway terminals 104 and satellites 102 may use different types of communication links to establish the SAT-GW link.

The illustrated communication signal paths in the satellite communication system 100 can further include links between respective pairs of the satellites 102 in the satellite mesh topology 107, which may be referred to as SAT-SAT links. In the exemplary embodiment, the SAT-SAT links are implemented as optical frequency links, or simply “optical” or “laser-based” links. For example, each of the satellites 102 also includes one or more laser communication terminals 105 for transmitting and receiving laser-based (e.g., optical) signals. The laser communication terminals 105 may be dynamically oriented with respect to the satellite 102 on which they are mounted to enable the laser communication terminals of each satellite 102 to track, and maintain the SAT-SAT links with, other satellites 102 in relative motion with respect to the satellite 102. In the exemplary embodiment, each of the satellites 102 includes multiple laser communication terminals 105 that may be independently oriented to enable each satellite to simultaneously maintain SAT-SAT links with multiple other satellites 102. However, other types of communication links are also contemplated for implementing the SAT-SAT links. Moreover, while only three satellites 102 are illustrated, satellite communication system 100 may include many thousands of satellites 102, and different pairs of the satellites 102 may use different types of communication links to establish the respective SAT-SAT link between them. Additionally, one or more of the satellites 102 may not be configured to establish SAT-SAT links with other satellites 102.

In some instances, communications between the user terminal 112 and the ground-based network 120 may be routed through a particular satellite 102 via a UT-SAT link, and through that same satellite directly to and from the gateway terminal 104 via a SAT-GW link, as shown in path A, without being routed through any other satellites 102. In other words, in some instances it is not necessary for the satellite 102 to utilize or maintain SAT-SAT links with other satellites, or even to be capable of establishing SAT-SAT links with other satellites, for the satellite communication system 100 to route communications between the user terminal 112 and the gateway terminal 104. In other instances, communications between the ground-based network 120 and the user terminal 112 having a UT-SAT link with the particular satellite 102 may be routed through a different satellite 102 that has established a SAT-GW link with the gateway terminal 104, as shown in path B, using one or more SAT-SAT links between the satellites 102 in the satellite mesh topology 107.

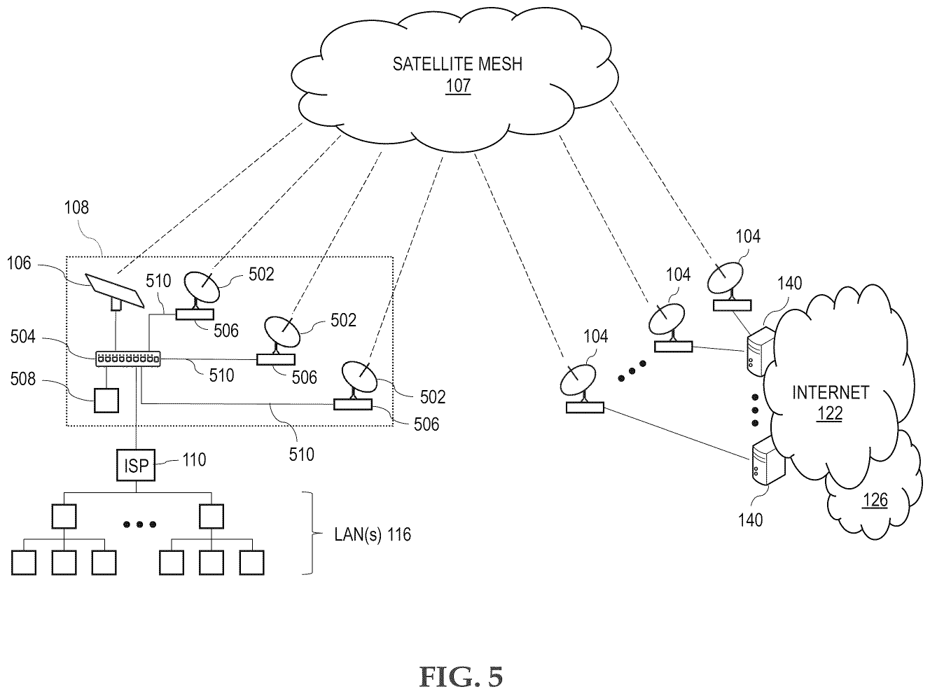

The illustrated communication signal paths in the satellite communication system 100 can further include a link between one of the satellites 102 in the mesh and the community gateway 108, which may be referred to as a SAT-CGW link. In the exemplary embodiment, the SAT-CGW link is implemented in the same fashion as the SAT-GW link, for example as a Ka-band or E-band radio frequency (RF) link. In particular, the SAT-CGW link at the satellites 102 can be implemented by the same gateway-wavelength antenna 109 used for making SAT-GW links, and the community gateway 108 can also include one or more community gateway (CGW) antennas 502 (shown in FIG. 5) for transmitting RF signals to and receiving RF signals from the satellite's gateway-wavelength antenna 109. For example, the CGW antennas 502 can be implemented as parabolic antennas and the RF SAT-CGW links can be implemented in the Ka band, the E band, or both. However, other types of communication links are also contemplated for implementing the SAT-CGW link. For example, the satellites 102 may also include laser communication terminals 105 that can serve a dual function as the gateway-wavelength antenna 109, as described above, and the community gateway 108 may also include one or more laser communication terminals for communication with the satellites 102 when atmospheric weather conditions are favorable for ground-to-space (and space-to-ground) laser transmission. It should be understood that the community gateway 108 can include multiple antennas in any combination of parabolic antennas, laser communication terminals, or other type of communication links. Moreover, while only one community gateway 108 and three satellites 102 are illustrated, the satellite communication system 100 may include thousands of the community gateways 108 and many thousands of satellites 102, and different ones of the community gateways 108 and satellites 102 may use different types of communication links to establish the SAT-CGW link.

In embodiments in which the same gateway-wavelength antenna 109 of the satellite 102 is used to make both SAT-GW links and SAT-CGW links, one satellite 102 cannot connect simultaneously to one of the community gateways 108 and one of the gateway terminals 104. Accordingly, and in contrast to the routing options for the user terminals 112, in such embodiments routing from the community gateway 108 to a particular satellite 102, and from the particular satellite directly to one of the gateway terminals 104 to reach the PoP 140, is not available. However, communications between the community gateway 108 and the ground-based network 120 can still proceed within acceptable latency thresholds via indirect routing through the satellite mesh topology 107. In other words, requests for user data from the community gateway 108 can be routed to a first satellite 102 that has the SAT-CGW link with the community gateway 108, from the first satellite through one or more SAT-SAT links between the satellites 102 in the satellite mesh topology 107 to a different satellite 102 that has established a SAT-GW link with the gateway terminal 104, and then via the SAT-GW link to the PoP 140 and on to the ground-based network 120.

In the exemplary embodiment, satellite communication system 100 also includes satellite operations (“SatOps”) services 130 connected to the gateway terminal 104 from a centralized location. In the exemplary embodiment, each gateway terminal 104 is associated with a corresponding PoP 140, and the PoP 140 is connected to the centralized SatOps services 130 via a private backbone 126. The SatOps services 130 may transmit various operational and management instructions to the gateway terminal 104, as well as to the satellites 102 (via the gateway terminal) and to the user terminal 112 and the community gateway 108 (via the gateway terminal and the satellites). In the exemplary embodiment, the private backbone 126 may be implemented on an Internet-based secure cloud platform, such as Microsoft Azure® or Amazon Web Services® (AWS) by way of non-limiting examples. However, other implementations of the private backbone 126 are also contemplated.

In some embodiments, the site of the community gateway 108 can also include one or more “backbone” user terminals 106 hardwired to the community gateway 108 and configured to assist the community gateway 108 in making an initial connection to the satellite communication system 100. By way of background, the standard gateway terminals 104 can have a hard-wired connection to one or more of the PoPs 140, and therefore always have a pathway to request an initial connection to the satellite communication system 100 (for example, the request can be sent to a network address associated with the SatOps services 130 via the private backbone 126). As part of the initial connection protocol, the standard gateway terminals 104 can obtain topology schedule data from the SatOps services 130. Using precise, updated ephemeris information specified in the topology schedule data for the satellites that will be in view in the near future, the standard gateway terminals can efficiently establish their scheduled SAT-GW links.

By contrast, the community gateway 108 has no hardwired connection to a PoP 140, and thus has no pre-existing pathway to request an initial network connection. Instead, the community gateway 108 must somehow be able to establish a pathway through one of the satellites 102 to request an initial connection to the satellite communication system 100, before receiving any current topology schedule data. Absent the precise, updated ephemeris information, a sky search by the parabolic antennas of the community gateway 108 itself to find a satellite 102 and establish an initial SAT-CGW link could be relatively inefficient, because the parabolic antennas must be physically slewed to find and track the satellites 102, which limits an efficiency of searching the sky.

On the other hand, the standard user terminals 112 are configured to connect to the satellite communication system 100 by performing a relatively efficient sky search for the satellites 102 using the directional RF beams generated by their phased array antennas. The backbone user terminal 106 can be a version of the user terminal 112 that is adapted to perform a similar initial sky search for the community gateway 108. In other words, the backbone user terminal 106 can be similar or identical in structure to the standard user terminals 112, and the backbone user terminal 106 can be configured to perform, in association with a start-up, re-boot, or other initialization of the community gateway 108, a sky search and acquire a BUT-SAT link, where “BUT” designates that the link involves the backbone user terminal 106 rather than a standard user terminal 112. The backbone user terminal 106 can be configured to use the BUT-SAT link to obtain operational and management information for the community gateway 108, such as initial topology schedule data for community gateway (CGW) antennas 502 (shown in FIG. 5), from the SatOps services 130 via the private backbone 126, rather than to handle requests for data from end users using the standard UT-SAT link.

For example, to establish an initial connection to the satellite communication system 100, the community gateway 108 can execute the same protocol applied by the standard gateway terminals 104, but can route the request through the hardwired connection to the backbone user terminal 106 (instead of through one of the Pops 140, as done by the standard gateway terminals 104). After the community gateway 108 obtains the precise, updated ephemeris information for the satellites 102 via the initial connection protocol through the backbone user terminal 106, the community gateway 108 can use the precise, updated ephemeris information to facilitate efficient pointing and slewing of the CGW antennas 502 to establish the high-throughput SAT-CGW link. However, other implementations for requesting an initial connection to the satellite communication system 100 or receiving the initial topology schedule data, including but not limited to performing a sky search for a satellite link using the CGW antennas 502, are also contemplated.

Additionally or alternatively, the one or more backbone user terminals 106 can be used to maintain, via the BUT-SAT link (which can be repeatedly renewed with different satellites as they come into view and then exit over the site of the community gateway 108) and the private backbone 126, an operational connection to the SatOps services 130 that persists after the community gateway 108 establishes the initial network connection. In other words, the one or more backbone user terminals sited with the community gateway 108 can provide an independent pathway for routing of operational and management information between the SatOps services 130 and the community gateway 108, while the SAT-CGW link is simultaneously used exclusively for handling traffic for the ISP 110. Alternatively, the SAT-CGW link can be used both for routing of operational and management information between the SatOps services 130 and the community gateway 108, and for handling traffic for the ISP 110.

### Satellite Constellation

For global coverage having reduced latency, satellite communication system 100 employs non-geostationary satellites, and more specifically low-Earth orbit (LEO) satellites 102. Geostationary-Earth orbit (GEO) satellites orbit the equator with an orbital period of exactly one day at a high altitude, flying approximately 35,786 km above mean sea level. Therefore, GEO satellites remain in the same area of the sky as viewed from a specific location on Earth. In contrast, LEO satellites orbit at a much lower altitude (typically less than about 2,000 km above mean sea level), which reduces Earth-satellite signal travel time and therefore reduces communication latency relative to GEO satellites.

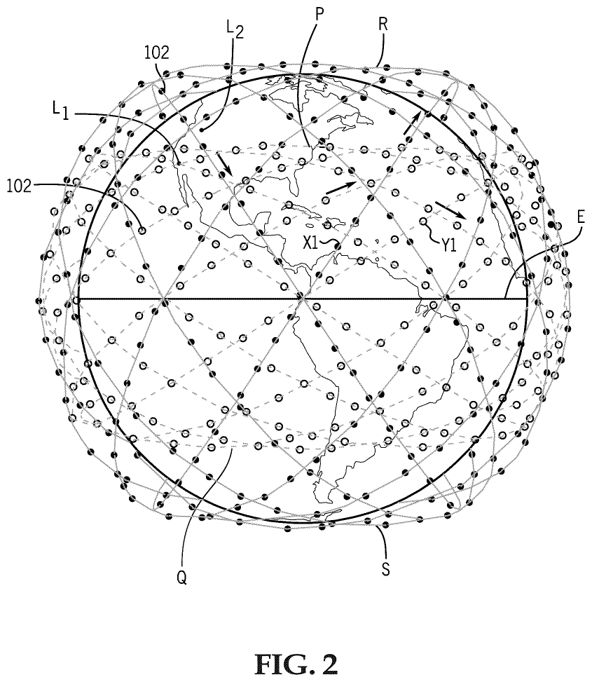

However, a stable low-Earth orbit necessarily corresponds to a much shorter orbital period as compared to GEO satellites. For example, at a particular altitude, a LEO satellite 102 may orbit the Earth, for example, once every 95 minutes. Further in the exemplary embodiment, the low-Earth orbits of satellites 102 are prograde. Therefore, LEO satellites do not remain stationary relative to a specific location on Earth, but rather advance generally eastward with respect to the Earth's surface. In addition, the lower orbital altitude means that, as compared to a GEO satellite, a LEO satellite has a more limited line of sight. For example, a LEO satellite in an equatorial orbit would not have a “line of sight” for direct communication with user terminals or gateway terminals at middle or upper latitudes on Earth, such as at locations L1 (corresponding to Los Angeles, California) and L2 (corresponding to Seattle, Washington) identified in FIG. 2.

Accordingly, satellite communication system 100 may include a large number, for example several thousand, satellites 102 arranged in a constellation of inclined orbits that ensures that at least some satellites 102 are always crossing the sky within range of community gateways 108 and user terminals 112 at any given Earth latitude and longitude. One non-limiting embodiment is illustrated in FIG. 2, which is a schematic showing an example of satellite planar orbital patterns X1 and Y1 of satellites 102 around a rotating Earth. In FIG. 2, the satellites in pattern X1 are represented by closed circles, and the satellites in pattern Y1 are represented by open circles, with arrows illustrating a general direction of travel of the satellites in each string. Each satellite string may include a number of equally spaced or substantially equally spaced satellites 102. More specifically, in a frame that rotates with the Earth, satellites 102 in the first string X1 are in discrete orbits sharing a first inclination, and satellites 102 in the second string Y1 are in discrete orbits sharing a second inclination different from the first inclination.

The angle of inclination of the satellites typically corresponds to an upper and lower limiting Earth latitude (indicated as P and Q for satellite string X1, and as R and S for satellite string Y1) of the orbital paths of the satellites. Although two strings at different inclinations are illustrated, other numbers of strings, such as one string or more than two strings, are also contemplated. Moreover, the illustrated angles of inclination are examples, and other angles of inclination for a single string or for multiple strings are also contemplated. Orbital patterns X1 and/or Y1 may be designed as repeating ground track systems, or may have a drifting pattern relative to the Earth's rotation rate.

### Ground Terminal Mesh Topology

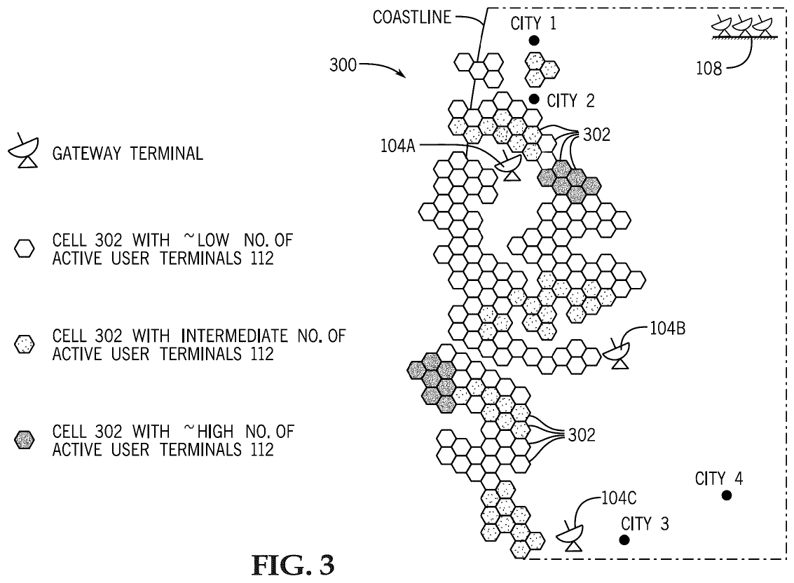

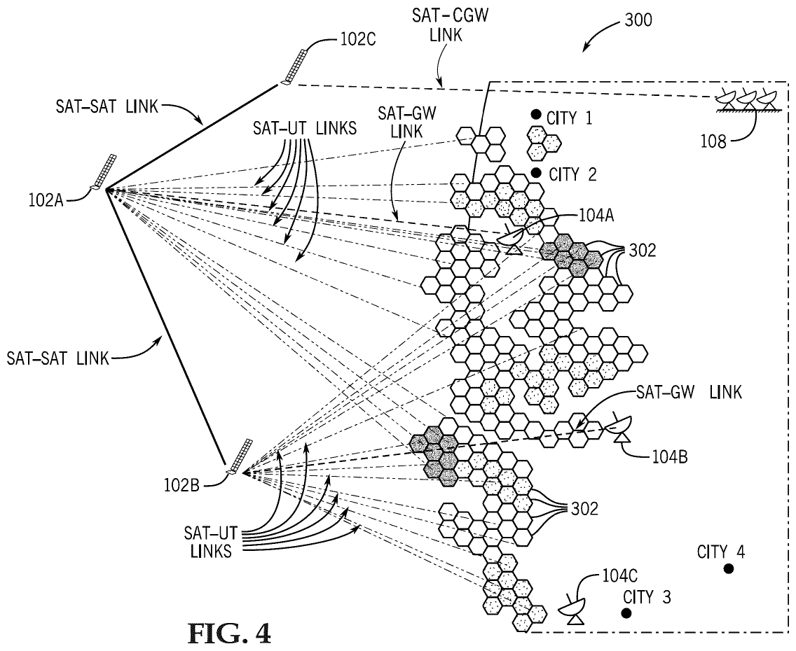

FIG. 3 illustrates a not-to-scale aerial view of an exemplary ground area 300 that may be serviced by the satellite communication system 100. More specifically, the ground area 300 can include a number of user terminals 112 and community gateways 108 that may transmit requests for user data to be serviced ultimately by, e.g., server 150 (shown in FIG. 1B) or other data sources. The requests for user data, and the data responsive to the requests, may be routed to and from the user terminals via the network topology of the satellite communication system 100. FIG. 4 illustrates a not-to-scale aerial view of requests from, and responses to, ground area 300 being serviced by example satellites 102A, 102B, and 102C of the group of satellites 102 in communication with example gateway terminals 104A, 104B, and 104C.

The network topology of the satellite communication system 100 may be analogized to a map of roads (travel routes) interconnecting a group of cities (nodes). For road travel between two cities separated by a significant distance, several different road routes may be available, each using roads that connect a different set of intermediate cities. One must know which intermediate cities are connected by roads, and how much traffic there will be on each road, in order to select the best travel route between the two cities.

Similarly, for data travel between two nodes in the satellite communication system 100 (e.g., between a community gateway 108 or a user terminal 112 and a data source, such as the ground-based server 150 (shown in FIG. 1)), several different network routes may be available, each using links that connect a different set of intermediate nodes (i.e., satellites and gateways). One must know which satellites are within the field of view of the user terminal, which satellites and gateways are connected by data links, and how much traffic there will be on each link, in order to select the best data route between the requesting community gateway or user terminal and the data source. The topology of the satellite communication system 100 is more complex than a road map, however, because the “roads” (data communication routing through the mesh topology) must be frequently reconfigured to accommodate the relative motion of the satellites 102 with respect to the ground terminals 112, 108, and 104, and in some cases the relative motion of the satellites 102 with respect to each other. In some embodiments, the reconfiguration must occur once or more per minute to accommodate the relative motion of the satellites 102.

In the exemplary embodiment, the ground area 300 includes user terminals 112 grouped into service cells 302 that are geographically fixed relative to the Earth. Although each service cell 302 is illustrated as a hexagonally shaped area, service cells 302 of any shape are contemplated. Moreover, although the service cells 302 are illustrated as having a particular size, other sizes of service cells 302 are contemplated. Service cell size may be a function of multiple factors including, but not limited to, altitude of the satellite constellation, number of satellites in the satellite constellation, number of Earth-based users, geography, etc. The ground area 300 also includes one or more gateway terminals 104.

In some embodiments, the user terminals 112 in each service cell 302 are further grouped into different “lanes” within the service cell 302. The lanes may be, but need not be, associated with particular geographical subregions within the service cell 302. Each combination of a service cell 302 and lane may be associated with a unique network address prefix within the satellite communication system 100, such that all user terminals 112 in a specific service cell and lane can be addressed as a group. For example, if the network addressing scheme is structured similar to Internet Protocol (IP) addressing, each service cell and lane may be associated with a unique network address prefix.

In some embodiments, each user terminal 112 is configured to address requests for user data to a particular PoP 140 (shown in FIG. 1B), which may be referred to as the “home” PoP 140 for the user terminal. The home PoP 140 handles each request for user data by accessing resources on the ground-based network 120 or nodes of the satellite communication system 100 to obtain the requested data, and by accessing the SatOps services 130 to obtain routing instructions for returning the requested data.

In comparison to the user terminals 112, the community gateways 108 are each configured to handle a much higher data throughput, as befits the ISP 110 servicing one or more LANs 116. Each community gateway 108 can be assigned a dedicated network address within the satellite communication system 100, rather than being one of many destinations within the network address of one of the service cells 302 as the user terminals 112 are. For example, each community gateway 108 can have its own dedicated service cell network address. Other implementations for addressing the user terminals 112 or the community gateways 108 are also contemplated.

With reference to FIGS. 1-4, as a result of the motion of satellites 102 relative to the Earth's surface, a particular satellite 102 may be in a position to establish communication with a particular community gateway 108, or with the user terminals 112 in a particular service cell 302, for only a limited time window, such as less than ninety minutes, less than sixty minutes, less than thirty minutes, less than fifteen minutes, less than five minutes, or less than one minute. In the exemplary embodiment, the SatOps services 130 assigns, to each community gateway 108 and to each service cell 302 (and in some embodiments to each lane within the service cell), one or more of the satellites 102 to be available for linking on a slot-by-slot basis, in which each slot represents a period of time. The period of time, i.e., time slot length, may be selected to accommodate the limited time windows over which any particular satellite may be within the field of view of the community gateway 108 or of the user terminals in the service cell. Time slot length may be a function of orbital velocity of the satellite constellation (which in turn may be a function of altitude of the satellite constellation), number of satellites in the satellite constellation, size of the service cells, etc. For example, the time slot length can be between 10 and 120 seconds inclusive. Other time slot lengths are also contemplated.

The SatOps services 130 may transmit topology schedule data to the user terminals 112 in each service cell 302 (e.g., via the gateway terminal 104 and the satellite 102 that are currently providing the physical path for the service cell 302 and lane associated with the respective user terminal 112). The topology schedule data transmitted to the user terminals specifies one or more of the satellites 102 that will be available for connectivity to the respective user terminal 112 during one or more future time slots. The topology schedule data may also include pointing instructions for the phased array antenna of the user terminal (or for the appropriate antenna for other types of UT-SAT links) needed to establish and maintain the corresponding UT-SAT link during the future time slot, as derived from the (known) relative motion of the satellite and the user terminal. In conjunction with the arrival of the future time slot, the user terminal 112 initiates a UT-SAT link with one of the satellites 102 specified by the topology schedule data for that time slot. The topology schedule data can be transmitted to the backbone user terminals 106 in a similar fashion.

Similarly, the SatOps services 130 may transmit topology schedule data to the community gateways 108. For example, the topology schedule data can be sent via the gateway terminal 104 and the satellite 102 that are currently in communication with the backbone user terminal 106 of the respective community gateway 108 via the BUT-SAT link, and from the backbone user terminal 106 through a hardwired connection to the community gateway 108. For another example, the topology schedule data can be sent via the gateway terminal 104 and the satellite 102 that are currently in communication with the respective community gateway 108 via the SAT-CGW link. The topology schedule data transmitted to the community gateways 108 specifies one or more of the satellites 102 that will be available for connectivity to the respective community gateway 108 during one or more future time slots. The topology schedule data may also include pointing instructions for the parabolic antennas of the community gateway 108 (or for the appropriate antenna for other types of SAT-CGW links) needed to establish and maintain the corresponding SAT-CGW link during the future time slots, as derived from the (known) relative motion of the satellite and the community gateway. In conjunction with the arrival of the future time slot, the parabolic antennas of the community gateway 108 each initiate a SAT-CGW link with the satellite 102 specified by the topology schedule data for that time slot.

As discussed above with respect to user terminals, a particular satellite 102 also may be in a position to establish communication with a particular gateway terminal 104 for only a limited time window. In the exemplary embodiment, the SatOps services 130 also assigns each satellite 102 to one of the gateway terminals 104 on the slot-by-slot basis. The SatOps services 130 may transmit topology schedule data to the gateway terminals and to the satellites (e.g., via the gateway terminal 104 that is currently in communication with the respective satellite 102). The topology schedule data specifies an expected connectivity between each gateway terminal 104 and one or more satellites 102 during one or more future time slots. The topology schedule data transmitted to each satellite 102 may also include pointing instructions for the gateway-wavelength antenna 109 of the satellite (or for the appropriate antenna for other types of SAT-GW links), and likewise the topology schedule data transmitted to each gateway terminal 104 may also include pointing instructions for the parabolic antenna of the gateway terminal (or for the appropriate antenna for other types of SAT-GW links), needed to establish and maintain the corresponding SAT-GW link during the future time slots, as derived from the (known) relative motion of the satellite and the gateway terminal. In conjunction with the arrival of the future time slot, the satellite 102 initiates a SAT-GW link with the gateway terminal 104 specified by the topology schedule data for that time slot.

For example, as illustrated in FIG. 4, three satellites 102A, 102B, and 102C are approaching ground area 300 at the start of a particular time slot. The satellites and the community gateway 108 have previously received topology schedule data for the particular time slot, specifying satellite 102C for the SAT-CGW link with the community gateway 108 during the particular time slot. Accordingly, in conjunction with the arrival of the time slot, the satellite 102C positions its gateway-wavelength antenna 109 and establishes the SAT-CGW link with the community gateway 108 to enable communication between the ISP 110 (shown in FIG. 1B) and the satellite communication system 100.

The service cells 302 in the ground area have varying numbers of active user terminals 112. The user terminals 112 in each service cell 302 have previously received topology schedule data for the particular time slot, specifying satellites 102A, 102B, and 102C as being available for UT-SAT links during the particular time slot. Accordingly, in conjunction with the arrival of the time slot, the various user terminals 112 in ground area 300 establish respective links with satellite 102A, 102B, or 102C for communication with satellite communication system 100. Notably, because the satellite 102C uses the phased array antenna 111, rather than the gateway-wavelength antenna 109, for the UT-SAT links, the satellite 102C can maintain both UT-SAT links and the SAT-CGW link during the same time slot. However, in some implementations the satellite 102C is not used for UT-SAT links for the slots in which the SAT-CGW link is scheduled. For example, in some implementations the satellite computer system 103 can service a higher throughput on the SAT-CGW link when no user terminal data requests are being serviced.

As noted previously, because satellite 102C has been instructed to use its gateway-wavelength antenna 109 to establish the SAT-CGW link with the community gateway 108 during the time slot, satellite 102C is not instructed to make a SAT-GW link during the time slot. Instead, the satellite computer system of satellite 102C is configured to route data between the community gateway 108 and the ground network 120 through the satellite mesh topology 107 to one of the gateway terminals 104. For example, the data can be routed through the SAT-SAT link between satellites 102C and 102A and the SAT-GW link between satellite 102A and gateway terminal 104A. For another example, the data can be routed through the SAT-SAT link between satellites 102C and 102A, the SAT-SAT link between satellites 102A and 102B, and the SAT-GW link between satellite 102B and gateway terminal 104B. Other numbers and locations of gateway terminals 104, satellites 102, and community gateways 108, and other implementations of links therebetween, with respect to the ground area 300 are also contemplated.

### Satellite Mesh Topology

The term “satellite mesh topology” refers specifically to the network interconnectivity among the group of satellites 102 as nodes within the overall mesh network, and the configuration of the satellite mesh topology 107 changes dynamically over time in the satellite communication system 100 to account for relative motion among the satellites 102 and other factors.

In the exemplary embodiment, the SatOps services 130 assigns SAT-SAT links among pairs of satellites 102 on the slot-by-slot basis. The SatOps services 130 may include the link assignments in the topology schedule data transmitted to each satellite 102, as discussed above (e.g., via the gateway terminal 104 currently in communication with the respective satellite 102). More specifically, the topology schedule data may specify a connectivity of the respective satellite 102 to other satellites in the satellite mesh topology 107 during the one or more future time slots. The topology schedule data may also include pointing instructions for each of the satellite's laser communication terminals 105 (or for the appropriate antenna for other types of SAT-SAT links) needed to establish and maintain the specified SAT-SAT links during the future time slots, as derived from the (known) relative motion of the pair of satellites. In conjunction with the arrival of the future time slot, the satellite computer system 103 dynamically establishes SAT-SAT links with the other satellites specified by the topology schedule data for that time slot, as well as the SAT-GW link with the gateway terminal 104 (or the SAT-CGW link with the community gateway 108) specified for that time slot.

### Example Implementation Of The Community Gateway

FIG. 5 is a simplified block diagram of example elements of the community gateway 108 in combination with the satellite communication system 100. In the exemplary embodiment, the community gateway 108 includes a plurality of community gateway (CGW) antennas 502 each configured to communicate with the satellite mesh topology 107 (for example, via the gateway-wavelength antennas 109 of the satellites 102 as shown in FIG. 1B). The community gateway 108 also includes a network switch 504 coupled in signal communication between the CGW antennas 502 and the ISP 110. Each CGW antenna 502 includes a network interface processor 506 in signal communication with the network switch 504 via an antenna-switch signal path 510.

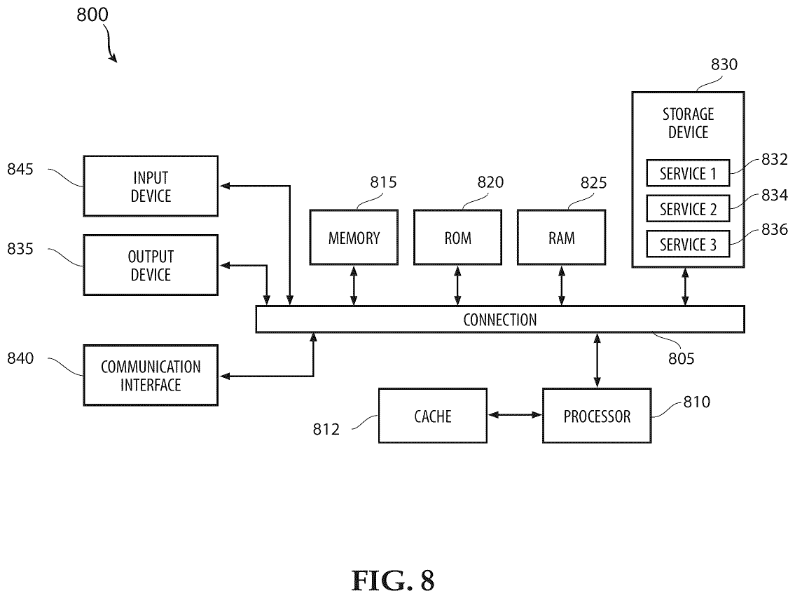

More specifically, the network switch 504 can include one or more processors (for example, as shown in an example in FIG. 8) configured to manage the switching of data packets between the ISP 110 and the different network interface processors 506 connected to the network switch. Each network interface processor 506 can be configured to receive data packets from the network switch 504 and provide the data packets to the associated CGW antenna 502 for transmission to the satellite mesh topology 107, and to route data packets received from the satellite mesh topology 107 by the associated CGW antenna 502 to the network switch 504. The network interface processors 506 can each include a network interface processor memory storing instructions executable to cause the network interface processor to perform network interface steps. For example, each network interface processor 506 (and associated network interface processor memory) can be implemented as one or more application-specific integrated circuits (ASICs), field-programmable gate arrays (FPGAs), central processing units (CPUs) coupled to random access or read-only memory devices, other suitable types of processors or memories, or any combination thereof. Likewise, the network switch 504 can include a network switch memory storing instructions executable to cause the network switch to perform network switch steps. For example, the one or more processors of the network switch 504 (and associated network switch memory) can be implemented as one or more application-specific integrated circuits (ASICs), field-programmable gate arrays (FPGAs), central processing units (CPUs) coupled to random access or read-only memory devices, other suitable types of processors or memories, or any combination thereof.

As discussed above, the community gateway 108 can also include one or more backbone user terminals 106 configured to communicate with the satellite mesh topology 107 (for example, via the phased array antennas 111 of the satellites 102 as shown in FIG. 1B). The community gateway 108 can also include a control processor 508 configured to enable configuration, monitoring, and control of one or more of: the CGW antennas 502, the network switch 504, the network interface processors 506, the backbone user terminal 106, or other elements of the community gateway 108. For example, the control processor 508 can obtain the topology schedule data received via the backbone user terminal 106 from the SatOps services 130 (shown in FIG. 1B), and command the CGW antennas 502 to make the CGW-SAT links specified for the time slots in the topology schedule data.

Certain other elements of the satellite communication system 100 are illustrated in FIG. 5 with the same reference numbers used in FIGS. 1A and 1B. For example, a plurality of the gateway terminals 104 are illustrated in signal communication between the satellite mesh topology 107 and a plurality of the Pops 140, which provide access to the Internet 122 (and to the private backbone 126 of the satellite communication system 100). More specifically, end users on the one or more LANs 116 serviced by the ISP 110 can obtain access to the Internet 122 via the network switch 504, the antenna-switch signal paths 510, the CGW antennas 502, the satellite mesh topology 107, the gateway terminals 104, and the PoPs 140. Likewise, the control processor 508 can obtain access to the private backbone 126 via the network switch 504, the antenna-switch signal paths 510, the CGW antennas 502, the satellite mesh topology 107, the gateway terminals 104, and the PoPs 140.

The plurality of CGW antennas 502 can significantly reduce a downtime in a connectivity between the network switch 504 and the Internet 122. For example, in some embodiments, each satellite 102 can be in a low Earth orbit moving with a velocity, relative to the surface of the Earth, that causes the satellite to be in view of the CGW antennas 502 during a visibility window that lasts approximately ninety to one hundred fifty seconds. In other words, each CGW antenna 502 loses its connection to the satellite mesh topology 107 approximately every two minutes as the current satellite disappears over the horizon, and must physically slew to point at a different satellite 102 approaching over the opposite horizon in order to establish a new connection to the satellite mesh topology 107. Moreover, in some embodiments, the process of slewing the CGW antenna 502 to acquire a different satellite 102 can require an acquisition time window of approximately eight to fifteen seconds. As no connection to the satellite mesh topology 107 is present during the acquisition time window, each individual CGW antenna 502 can be without a connection to the PoP 140 (and, thus, without a connection to the Internet 122) approximately five to fifteen percent of the time. Other visibility windows, acquisition time windows, and percent downtimes are also contemplated.

Typically, in order to provide a sufficient quality of service to the end users on the LANs 116, the ISP 110 requires a much lesser downtime in the connection to the Internet 122 than can be provided by a single CGW antenna 502. Accordingly, the community gateway 108 can include multiple CGW antennas 502 configured to operate such that at least one of the CGW antennas 502 substantially always has an active connection to the satellite mesh topology 107. For example, assuming that the satellite mesh topology 107 includes a sufficient number and spacing of satellites 102, the connections specified in the topology schedule data for each of the CGW antennas 502 can be timed such that, while one of the CGW antennas 502 is in the acquisition time window, at least one other of the CGW antennas 502 has an active connection to the satellite mesh topology 107. In some embodiments, the community gateway 108 can achieve a percent downtime of less than or equal to 0.01 percent by coordinating operations among three CGW antennas 502. Other percent downtimes, as well as other numbers of CGW antennas 502 included at the community gateway 108, are also contemplated.

As noted above, such coordination among multiple antennas at a site would conventionally require sophisticated software and communication links between controllers of the multiple CGW antennas to track and detect when links are made and lost by each CGW antenna, with sufficient precision to divert network traffic away from the CGW antenna(s) that have no active link to the satellite mesh topology 107. In addition to a cost of installation and maintenance associated with custom links between antenna controllers, this conventional approach does not take into account potential communication lapses in the signal path between each CGW antenna 502 and a corresponding PoP 140, such as interruptions in one of the SAT-SAT links in the path or interruptions in the SAT-GW link between the final satellite 102 in the satellite mesh path and the gateway terminal 104.

In some embodiments, the present disclosure reduces or eliminates these deficiencies in the conventional approach by configuring the network switch to route data packets received from the ISP 110 to each of the CGW antennas 502 only when that CGW antenna 502 has a healthy connection all the way through the satellite communication system 100 to one of the Pops 140. However, it is also contemplated that the routing of data packets received from the ISP 110 to each of the CGW antennas 502 can be based on a health of connections from the CGW antennas 502 to nodes of the satellite communication system 100 other than the Pops 140.

In some embodiments, the CGW antennas 502, or more specifically the respective network interface processor 506 included with each of the CGW antennas 502, can be configured to report to the network switch 504 a connection status of the connection between the CGW antenna 502 and a node of the satellite communication system 100. The network switch 504 can be configured to route data packets to the CGW antennas 502 for transmission through the satellite communication system 100 based on the reported connection status from each of the CGW antennas 502. For example, if a first of the three CGW antennas 502 reports a positive connection status (for example, a current healthy connection to one of the Pops 140) while the other two CGW antennas 502 fail to report a positive connection status or, alternatively, actively report a negative connection status (for example, by reporting a current absence of a healthy connection to any of the PoPs 140), the network switch 504 in response can route all user data traffic from the ISP 110 through the first CGW antenna 502. Alternatively, if more than one of the CGW antennas 502 report a positive connection status, the network switch 504 in response can route user data traffic from the ISP 110 solely through the more than one CGW antennas 502 reporting the positive connection status. For example, the network switch 504 can apply a suitable load-balancing strategy to allocate the data packets among the more than one CGW antennas 502.

Notably, configuring the network interface processors 506 to report the connection status of their corresponding CGW antennas 502 directly to the network switch 504, and configuring the network switch 504 to make routing decisions to the CGW antennas 502 based on the reports, avoids a need for adding a layer of cross-communication between the CGW antennas 502 to determine which of the CGW antennas 502 should be used to route data packets to the satellite communication system 100.

The more rapidly the network switch 504 can react to changes in the connection status of the CGW antennas 502, the fewer data packets will be inadvertently routed to a CGW antenna 502 that has lost its connection to the satellite communication system 100. In some embodiments, the network interface processor 506 is configured to use a path failure detection protocol supported by the network switch 504 to report the connection status rapidly in response to a change. More specifically, the network switch 504 and each network interface processor 506 are configured to operate as peers in the path failure detection protocol. For example, the network switch 504 can be configured to execute a plurality of instances of the path failure detection protocol, and each instance can peer with the path failure detection protocol executing at the network interface processor 506 of a corresponding one of the plurality of CGW antennas 502.

One non-limiting example of such a path failure detection protocol is Bi-Directional Forwarding Detection (BFD), which can cause the network switch to recognize a path failure within a time window on the order of 10 to 100 milliseconds. Technical details of a version of BFD are described in RFC 5880 to RFC 5884 published by the Internet Engineering Task Force (IETF) (June 2010). The use of a standardized path failure detection protocol such as BFD enables the use of a commercial off-the-shelf implementation of the network switch 504 (in other words, by installing a commercial off-the-shelf network switch that already supports the standardized path failure detection protocol), which can simplify installation and configuration of the community gateway 108. However, path failure detection protocols which require customized programming modifications at the network switch 504 are also contemplated.

Conventionally, a path failure detection protocol deployed between the network switch 504 and the network interface processor 506, would be used to determine when the network link between the network interface processor 506 and the network switch 504 over the antenna-switch signal path 510 is broken. However, embodiments of the present disclosure can leverage features of the path failure detection protocol in an unconventional fashion to enable the network interface processor 506 to rapidly report to the network switch 504 the connection status between the network interface processor 506 and another node of the satellite communication system 100, for example one of the Pops 140.

For example, the path failure detection protocol can include path failure detection protocol packets sent by each of the two peers in the connection (in this case, the network switch 504 and the network interface processor 506) to the other. The path failure detection protocol can also define session states, and each path failure detection protocol packet sent by one of the peers includes an indicator for the current session state as observed by the sending peer. The session state observed by each peer changes in a defined fashion based on the local session state and the session state received from the other peer. The session state is nominally associated with a health of the connection between the two connected nodes (in this case, the network switch 504 and the network interface processor 506). For example, so long as each peer continues to receive path failure detection protocol packets from the other peer within an expected time frame, each peer will observe and report a session state corresponding to a healthy connection.

The session states can indicate one or more of a healthy connection, a faulty or “connection down” detection (that is, a previously healthy connection has transitioned to an unhealthy connection), a readiness to initiate a healthy connection, and an administrative disablement of the session (triggered, for example, by an instruction received from an upper layer protocol at the node processor) which indicates the connection has been taken down for administrative reasons rather than a fault detection. As an example, the BFD protocol defines an UP session state indicating a healthy connection, a DOWN session state indicating connection down, an INIT state indicating a readiness to return to a healthy connection, and an ADMIN_DOWN state indicating that an administrative disablement has occurred. Other types of session states are also contemplated.

In addition, the path failure detection protocol can define a state transition model that controls how the peers transition between session states in response to administrative commands received from an upper layer protocol at the node executing the peer or session states received from the other peer. For example, if a peer is in the “connection down” state, the state transition model can keep the peer in that state until the peer receives a path failure detection protocol packet from the other peer that indicates the other peer is (i) also in the connection down state, in which case the peer advances its session state to the “initialization” state; or (ii) in the “initialization” state, in which case the peer advances its session state to the “healthy connection” state.

For another example, if a peer is in the “initialization” state, the state transition model can keep the peer in that state until either (i) the peer receives a path failure detection protocol packet from the other peer that indicates the other peer is in the “initialization” state or the “healthy connection” state, in which case the peer advances its session state to the “healthy connection” state, or (ii) the peer receives a path failure detection protocol packet from the other peer that indicates the other peer is in the “administratively disabled” state, or the packet detection time window expires (that is, communication with the other peer has been lost), in which case the peer advances its session state to “connection down.”

For another example, if a peer is in the “healthy connection” state, the state transition model can keep the peer in that state until either (i) the packet detection time window expires, or (ii) the peer receives a path failure detection protocol packet from the other peer that indicates the other peer is in the “connection down” state or the “administratively disabled” state, in both of which cases the peer advances its session state to “connection down.”

In addition, the state transition model can move the peer from any session state to the “administratively disabled” session state in response to an instruction from an upper layer protocol at the node executing the peer. For example, the path failure detection protocol can define a disablement software call that can be used by the upper layer protocol at the node to set the session state to “administratively disabled” at that peer. As one example, BFD defines a call administrative_disable( ) for this purpose. In response to receiving, from the peer so instructed, path failure detection protocol packets indicating the “administratively disabled” session state, the other peer enters the “connection down” state and remains there until the peer so instructed is released from the “administratively disabled” session state.

The path failure detection protocol can also define an enablement software call that can be used by the upper layer protocol at the node executing the peer to release the session state from “administratively disabled” at that peer. As one example, BFD defines an administrative_enable( ) call for that purpose. The state transition model can move the peer from the “administratively disabled” state to the “connection down” state in response to the enablement call. The transition to the “connection down” session state causes the peer to resume sending path failure detection protocol packets to the other peer.

The path failure detection protocol operating at the network switch 504, for example in a standard configuration, will cause the network switch 504 to continue to route data packets from the ISP 110 through each CGW antenna 502 so long as the session state indicates a healthy connection. In response to the session state associated with the network interface processor 506 corresponding to any one of the CGW antennas 502 indicating an unhealthy connection, the path failure detection protocol operating at the network switch 504 will rapidly cause one or more upper layer protocols at the network switch 504 to cease routing data packets through that CGW antenna 502.

In certain embodiments of the present disclosure, each network interface processor 506 can be programmed to control the path failure detection protocol at that network interface processor 506 based on a connection status between the CGW antenna 502 and the other node of the satellite communication system 100 (for example, one of the Pops 140), rather than on the receipt of path failure detection protocol packets from the network switch 504. In effect, the network interface processor 506 can manipulate the session state of the path failure detection protocol to “trick” the network switch 504 into believing it has lost the connection to the CGW antenna 502, when in reality it is the connection between the CGW antenna 502 and the PoP 140 (or other node) that has been lost (for example, when the satellite 102 that was linked to the CGW antenna 502 has disappeared over the horizon). Likewise, when the network interface processor 506 re-establishes a connection with the PoP 140 (for example, when the CGW antenna 502 has established a new CGW-SAT link with another satellite 102 approaching over the opposite horizon), the network interface processor 506 can manipulate the session state of the path failure detection protocol to “trick” the network switch 504 into believing it has regained the connection to the CGW antenna 502, and in response the network switch 504 will rapidly resume forwarding at least a portion of the data packets from the ISP 110 through the corresponding CGW antenna 502.

Notably, this ability to manipulate the path failure detection protocol between the network switch 504 and the network interface processor 506 assumes that no faults are occurring in the actual network link over the antenna-switch signal path 510 between the network switch 504 and the network interface processor 506. This is typically a good assumption, as the community gateway 108 can be implemented with the network interface processors 506 and the network switch 504 co-located, for example in a same cabinet or a short distance away.

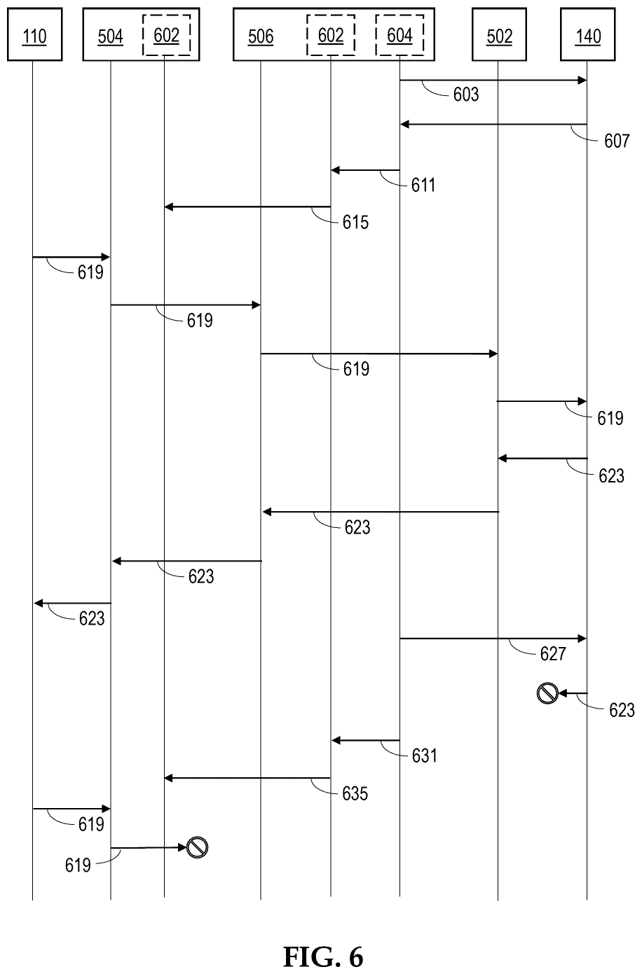

FIG. 6 illustrates an example data flow 600 between the ISP 110, the network switch 504, any one of the network interface processors 506, and the PoP 140. The network switch 504 and the network interface processor 506 can each execute an instance of the path failure detection protocol 602, such as but not limited to BFD. In addition, the network interface processor 506 can execute an executive module 604. The executive module 604 can serve as the upper layer protocol configured to control the path failure detection protocol 602 executing at the network interface processor 506. The executive module 604 can also be configured to establish one or more network communication pathways between the network interface processor 506 and the PoP 140. As noted above, although routing of data packets at the network switch 504 based on the health of the network communication pathway with the PoP 140 is illustrated in the example, the routing of data packets at the network switch 504 based on the health of the network communication pathway with another node of the satellite communication system 100 is also contemplated.

The executive module 604 can be configured to initiate 603 the one or more network communication pathways to the PoP 140 at a first time in response to the topology schedule data indicating that the corresponding CGW antenna 502 is scheduled to communicate user data over a new CGW-SAT link beginning at a second time. A “new” CGW-SAT link refers to the initial establishment of the CGW-SAT link with a first satellite 102 approaching over the horizon, for example after a previous CGW-SAT link by the same CGW antenna 502 with a second satellite 102 has ended in conjunction with the second satellite disappearing over the opposite horizon. The community gateway 108 can be configured to slew the CGW antenna 502 into place during a time slot immediately preceding the second time. The second time can coincide with the beginning of one of the time slots specified in the topology schedule data. In some embodiments, the first time can occur before the second time, that is, the slewing of the CGW antenna 502 into position to track the approaching satellite can be completed and the initiation 603 can occur prior to the beginning of the time slot in which the CGW-SAT link is scheduled to carry user data. In other words, the CGW antenna 502 can slew into position and establish the new CGW-SAT link, and the corresponding network interface processor 506 can initiate 603 the one or more network communication pathways to the PoP 140, during one or more time slots preceding the second time. Alternatively, the first time can occur concurrently with or later than the second time, which may cause slight communication delays. The PoP 140 can be configured to respond 607 to the network interface processor 506 with an indication that the one or more network communication pathways are successfully established.

The one or more network communication pathways to the PoP 140 can be one or more tunnels of a virtual private network (VPN) implemented over the satellite communication system 100. For example, the “tunnels” can be established by adding additional headers to the data packets routed over the one or more network communication pathways and by signing and encrypting the data packets with public/private key pairs, as in the IPSec VPN protocol described in RFC 1825 to RFC 1827 published by the IETF (August 1995). Other implementations of the one or more network communication pathways between the network interface processor 506 and the PoP 140, and other methods of determining the successful establishment of those pathways, are also contemplated.

Prior to receiving the response 607 indicating that the one or more network communication pathways between the network interface processor 506 and the PoP 140 are established, the session state of the path failure detection protocol 602 at that network interface processor 506 can be “administratively disabled,” which causes the network switch 504 not to route data packets from the ISP 110 through that network interface processor 506. In response to receiving the response 607 from the PoP 140 that the one or more network communication pathways are established, the executive module 604 can instruct 611 the path failure detection protocol 602 executing at the network interface processor 506 to report 615 the connection status as positive to the network switch 504. In response to the report 615 of the positive connection status, the network switch 504 can begin routing data packets 619 received from the ISP 110 to the network interface processor 506. As discussed above, the network interface processor 506 routes the data packets 619 to the PoP 140 through a physical path including the corresponding CGW antenna 502, the satellite mesh topology 107, and one of the gateway terminals 104 (shown in FIG. 1B), and through a virtual path corresponding to the established one or more network communication pathways. Likewise, return data packets 623 routed from the PoP 140 and addressed to an address associated with the ISP 110 can be forwarded through the one or more network communication pathways on the same physical infrastructure and received by the network interface processor 506, which can send the return data packets 623 through the network switch 504 to the ISP 110.

For example, the instruction 611 can be implemented as the executive module 604 making the enablement call to the path failure detection protocol 602 executing at the network interface processor 506. As noted above, in response to the enablement call, the path failure detection protocol 602 executing at the network interface processor 506 can transition to the “connection down” state and indicate the changed state in path failure detection protocol packets sent to the peer (in this case, the path failure detection protocol 602 executing at the network switch 504). The session state reported in one (or more) of these path failure detection protocol packets can serve as the report 615 of the positive connection status between the network interface processor 506 and the PoP 140. For example, the first path failure detection protocol packet sent by the network interface processor 506 after the transition can indicate the “connection down” session state (the default state when transitioning out of the “administratively disabled” state), and in response to receiving the packet with this session state, the path failure detection protocol 602 executing at the network switch 504 can transition from the “connection down” state to the “initialization” state and include this session state in the packet it sends back. In response to receiving the path failure detection protocol packet indicating the “initialization” state, the path failure detection protocol 602 executing at the network interface processor 506 can transition into the “healthy connection” session state. This state is reported in turn to the path failure detection protocol 602 executing at the network switch 504, which causes the network switch 504 to begin routing data packets 619 to the network interface processor 506.

In some embodiments, the executive module 604 can further enhance a speed at which the network switch 504 begins routing the data packets 619 to the network interface processor 506 associated with the new CGW-SAT link by causing, via the instruction 611, the path failure detection protocol 602 executing at the network interface processor 506 to include the “initialization” session state (that is, a readiness to initiate a healthy connection) in the report 615, rather than the default “connection down” session state. The inclusion of the “initialization” session state in the report 615 causes the path failure detection protocol 602 executing at the network switch 504 to transition immediately to the “healthy connection” state, rather than the “initialization” state, which reduces by one step the back-and-forth between the network switch 504 and the network interface processor 506 and thus enables the network switch 504 to more rapidly begin routing data packets 619 to the network interface processor 506.

Moreover, the path failure detection protocol 602 can define a poll functionality that prompts an immediate response packet from the peer (rather than waiting for the next packet sent on a periodic schedule). The executive module 604 can further enhance a speed at which the network switch 504 begins routing the data packets 619 to the network interface processor 506 associated with the new CGW-SAT link by including, in the instruction 611 to the path failure detection protocol 602, an instruction to send the path failure detection protocol packets using the poll functionality (for example, with the session state set to “initialization”). As one example, BFD defines a bit in the path failure detection protocol packet format that can be set to indicate a poll to the receiving peer. Because the poll functionality causes the receiving peer to immediately evaluate its session state to send a packet, rather than waiting for the next period interval to evaluate its session state and send the next packet, the polling functionality can reduce a time required for the path failure detection protocol 602 executing at the network switch 504 to inform the upper layer protocol (not shown) executing at the network switch 504 to begin routing the data packets 619 to the network interface processor 506.

The executive module 604 can further be configured to close 627 the one or more network communication pathways to the PoP 140 at a third time in response to the topology schedule data indicating that the corresponding CGW antenna 502 is scheduled to break the current CGW-SAT link at a fourth time. In response to the closing 627, the PoP 140 ceases routing the return data packets 623 back to the corresponding network interface processor 506. Rather, the PoP 140 can instead route the return data packets 623 addressed to the ISP 110 to one or more of the network interface processors 506 associated with other CGW antennas 502 (shown in FIG. 5) at the community gateway 108, provided that at least one other CGW antenna 502 has an operational CGW-SAT link with another satellite 102 during that time (which, as noted above, can be planned for in the topology schedule data for the CGW antennas 502, assuming there are a sufficient number of satellites 102 following each other over the ground area 300 shown in FIGS. 3 and 4).

The fourth time can coincide with the beginning of another one of the time slots specified in the topology schedule data. In some embodiments, the third time can occur before the fourth time, that is, the executive module 604 can close the one or more network communication pathways prior to the beginning of the time slot in which the CGW antenna 502 is scheduled to break the CGW-SAT link. This can facilitate the PoP 140 detecting the loss of the communication pathways and, in response, ceasing to route the return data packets 623 back to the corresponding network interface processor 506, prior to the physical link being broken, which can reduce data packet loss. Alternatively, the third time can occur concurrently with or later than the fourth time.

In association with the close 627 of the one or more network communication pathways to the PoP 140, the executive module 604 can instruct 631 the path failure detection protocol 602 executing at the network interface processor 506 to report 635 the connection status as negative to the network switch 504. In response to the report 635 of the negative connection status, the network switch 504 can cease routing data packets 619 received from the ISP 110 to the network interface processor 506. Rather, the network switch 504 can instead route the data packets 619 received from the ISP 110 to one or more of the network interface processors 506 associated with other CGW antennas 502 (shown in FIG. 5) at the community gateway 108.

For example, the instruction 631 can be implemented as the executive module 604 making the disablement call to the path failure detection protocol 602 executing at the network interface processor 506. As noted above, in response to the disablement call, the path failure detection protocol 602 executing at the network interface processor 506 can transition to the “administratively disabled” state and report that state in the path failure detection protocol packets to the peer (in this case, the path failure detection protocol 602 executing at the network switch 504). The session state reported in one (or more) of these path failure detection protocol packets can serve as the report 635 of the negative connection status between the network interface processor 506 and the PoP 140. For example, in response to receiving a packet with the “administratively disabled” state, the path failure detection protocol 602 executing at the network switch 504 can transition from the “healthy connection” state to the “connection down” state, which causes the network switch 504 to cease routing data packets 619 to the network interface processor 506.

In some embodiments, the executive module 604 can further enhance a speed at which the network switch 504 begins routing the data packets 619 away from the network interface processor 506 associated with the lost CGW-SAT link by causing, via the instruction 631, the path failure detection protocol 602 executing at the network interface processor 506 to report the “connection down” session state via the poll functionality of the path failure detection protocol 602. As discussed above, the poll functionality prompts an immediate response packet from the peer (rather than waiting for the next packet sent on a periodic schedule), which can reduce a time required for the path failure detection protocol 602 executing at the network switch 504 to inform the upper layer protocol (not shown) executing at the network switch 504 to stop routing the data packets 619 to the network interface processor 506.

Although examples have been described for the use of the path failure detection protocol 602, such as but not limited to BFD, other implementations determining how to dynamically route the data packets 619 and the return data packets 623 through the one or more CGW antennas 502 that have current operational connections to the PoP 140 (or to another node of the satellite communication system 100) are also contemplated.

In some embodiments, in order to further ensure that the percent downtime experienced by the community gateway 108 stays at or below a level acceptable to the ISP 110, the community gateway 108 also includes an additional CGW antenna 502 configured as a “hot spare.” For example, the community gateway 108 illustrated in FIG. 5 can have an additional fourth “hot spare” CGW antenna 502 in addition to the three illustrated CGW antennas 502. The hot spare CGW antenna 502 can have a hardware configuration substantially identical to that of the three “on-line” CGW antennas 502, and a software configuration that enables the “hot spare” to quickly take over the assigned CGW-SAT links and network routing of any of the three “on-line” CGW antennas 502 in response to any problem or event that unexpectedly causes the performance of that “on-line” CGW antenna 502 to drop below an acceptable level. For example, the “hot spare” can be powered on and ready to rapidly enter into service if needed.

Stated another way, the community gateway 108 can have a nominal number of CGW antennas 502 (such as three in the example illustrated in FIG. 5) expected to be “on-line,” plus a hot spare. The topology schedule data received for the community gateway 108 can include slot-by-slot CGW-SAT link assignments for each of the nominally on-line CGW antennas 502. The control processor 508 can command the on-line CGW antennas 502 to make CGW-SAT links according to the assigned topology schedule data, and can configure the corresponding network interface processors 506 to perform network routing through the on-line CGW antennas 502 as described above. As noted above, the control processor 508 can be configured to monitor a performance of the on-line CGW antennas 502. In particular, the control processor 508 can be configured to detect that a performance of any one of the on-line CGW antennas 502 has dropped below an acceptable level, and to switch the CGW-SAT links and network routing responsibilities of the low-performing CGW antenna 502 to the hot spare CGW antenna 502 in response to the detection. For example, the control processor 508 can configure the network interface processor 506 corresponding to the hot spare CGW antenna 502 to take over the network routing previously handled by the network interface processor 506 corresponding to the low-performing CGW antenna 502.

In some embodiments, the designation of “hot spare” can be periodically rotated among all of the CGW antennas 502 of the community gateway 108 to facilitate equalizing a usage of each of the CGW antennas 502.

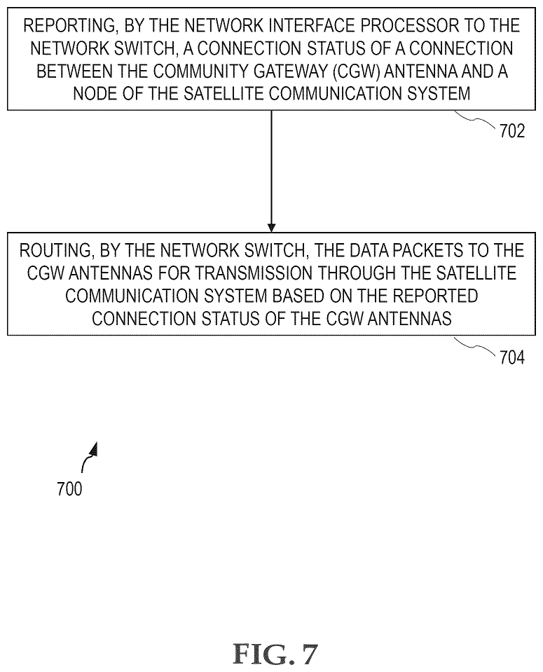

FIG. 7 illustrates an example method 700 of operating a community gateway for a satellite communication system, wherein the satellite communication system includes a plurality of terrestrial gateway terminals and a plurality of satellites, wherein the terrestrial gateway terminals are in communication with the Internet, wherein each of the satellites includes a satellite (SAT) gateway-wavelength antenna, wherein the community gateway includes a network switch and a plurality of community gateway (CGW) antennas, wherein the network switch is configured to route data packets received from an Internet Service Provider (ISP), wherein each CGW antenna is configured to communicate with the SAT gateway-wavelength antenna via a CGW-SAT link, and wherein each CGW antenna includes a network interface processor configured to route data packets between the network switch and the CGW antenna. The method 700 includes steps that can include one or more of: reporting, by the network interface processor to the network switch, a connection status of a connection between the CGW antenna and a node of the satellite communication system (702); and routing, by the network switch, the data packets to the CGW antennas for transmission through the satellite communication system based on the reported connection status of the CGW antennas (704).

A system embodiment can include a community gateway for a satellite communication system, wherein the satellite communication system includes a plurality of terrestrial gateway terminals and a plurality of satellites, wherein the terrestrial gateway terminals are in communication with the Internet, and wherein each of the satellites includes a satellite (SAT) gateway-wavelength antenna. The community gateway can include a network switch configured to route data packets received from an Internet Service Provider (ISP); and a plurality of community gateway (CGW) antennas, wherein each CGW antenna is configured to communicate with the SAT gateway-wavelength antenna via a CGW-SAT link, and wherein each CGW antenna includes a network interface processor configured to route data packets between the network switch and the CGW antenna. The network interface processor includes a network interface processor memory storing instructions executable to cause the network interface processor to perform network interface steps that can include reporting to the network switch a connection status of a connection between the CGW antenna and a node of the satellite communication system. The network switch includes a network switch memory storing instructions executable to cause the network switch to perform network switch steps that can include routing the data packets to the CGW antennas for transmission through the satellite communication system based on the reported connection status of the CGW antennas.

In some embodiments, the satellite communication system includes a plurality of Points of Presence (PoPs) on the Internet connected to the terrestrial gateway terminals, and the step of reporting the connection status includes reporting the connection status between the CGW antenna and one of the PoPs.

In certain embodiments, each of the satellites includes one or more laser communication terminals (LCTs), the satellites are configured to establish SAT-SAT links using the one or more LCTs to form a satellite mesh topology within the satellite communication system, and the step of reporting the connection status includes reporting the connection status of the connection between the CGW antenna and the one of the Pops established through the satellite mesh topology.

In some embodiments, the steps further include: executing, by the network interface processor, a path failure detection protocol supported by the network switch; and reporting, by the network interface processor, the connection status to the network switch using the path failure detection protocol.

In certain embodiments, the steps further include executing, by the network switch, a plurality of instances of the path failure detection protocol, wherein for each instance, the instance and the path failure detection protocol executing at the network interface processor of a corresponding one of the plurality of CGW antennas are peers in the path failure detection protocol.

In some embodiments, the path failure detection protocol defines session states and includes path failure detection protocol packets sent by each of the peers to the other of the peers, and the path failure detection protocol packets include an indicator for a current session state as observed by the sending peer.

In certain embodiments, the steps further include: initiating, by the network interface processor, one or more network communication pathways to the node of the satellite communication system; and receiving, by the network interface processor, a response from the node including an indication that the one or more network communication pathways are successfully established, wherein the step of reporting the connection status includes reporting a positive connection status in response to the indication.

In some embodiments, the step of initiating the one or more network communication pathways includes initiating one or more tunnels of a virtual private network (VPN) implemented over the satellite communication system.

In certain embodiments, the step of initiating the one or more network communication pathways is performed at a first time in response to topology schedule data indicating that the corresponding CGW antenna is scheduled to communicate user data over a new CGW-SAT link beginning at a second time.

In some embodiments, the step of reporting the positive connection status includes: making, by an executive module of the network interface processor in response to the step of receiving the response from the node, an enablement call to the path failure detection protocol executing at the network interface processor; and in response to the enablement call, sending the path failure detection protocol packets from the path failure detection protocol executing at the network interface processor to the path failure detection protocol executing at the network switch, wherein the session state reported in one or more of the path failure detection protocol packets serves as the report of the positive connection status.

In certain embodiments, the step of reporting the positive connection status further includes utilizing a polling functionality of the path failure detection protocol in the one or more path failure detection protocol packets.

In some embodiments, the steps further include, subsequent to reporting the positive connection status: receiving, by the network interface processor, return data packets routed from the node of the satellite communication system and addressed to an address associated with the ISP; and forwarding, by the network interface processor, the return data packets to the ISP through the network switch.

In certain embodiments, the steps further include closing, by the network interface processor, the one or more network communication pathways to the node of the satellite communication system at a third time in response to topology schedule data indicating that the corresponding CGW antenna is scheduled to break a current CGW-SAT link at a fourth time.

In some embodiments, the steps further include, in association with the step of closing the one or more network communication pathways, reporting, by the network interface processor, the connection status as negative to the network switch, and the step of routing the data packets to the CGW antennas for transmission through the satellite communication system includes ceasing, by the network switch in response to the report of the negative connection status, to route the data packets received from the ISP through the network interface processor.

In certain embodiments, the step of reporting the negative connection status includes: making, by an executive module of the network interface processor in association with the step of closing the one or more network communication pathways, a disablement call to the path failure detection protocol executing at the network interface processor; and in response to the disablement call, sending the path failure detection protocol packets from the path failure detection protocol executing at the network interface processor to the path failure detection protocol executing at the network switch, wherein the session state reported in one or more of the path failure detection protocol packets serves as the report of the negative connection status.

In some embodiments, the step of reporting the negative connection status further includes utilizing a polling functionality of the path failure detection protocol in the one or more path failure detection protocol packets.

In certain embodiments, each of the satellites further includes a satellite (SAT) phased array antenna, the community gateway further includes a backbone user terminal (BUT), and the steps further include communicating, by the backbone user terminal, with the SAT phased array antenna via a BUT-SAT link.

In some embodiments, the steps further include: performing, by the backbone user terminal in association with initialization of the community gateway, a sky search to acquire the BUT-SAT link; and obtaining, via the BUT-SAT link, topology schedule data specifying the CGW-SAT links to be made by the CGW antennas for a plurality of future time slots.

In certain embodiments, the satellite communication system further includes a satellite operations (SatOps) services platform, and the steps further include maintaining, by the backbone user terminal, an operational connection to the SatOps services platform after the initialization.

In some embodiments, the community gateway further includes a hot spare CGW antenna in addition to the plurality of CGW antennas and a control processor configured to enable configuration, monitoring, and control of the plurality of CGW antennas and the hot spare CGW antenna, and the steps further include: detecting, by the control processor, that a performance of any one of the plurality of CGW antennas has dropped below an acceptable level; and switching, by the control processor, the CGW-SAT links and network routing responsibilities of the any one of the plurality of CGW antennas to the hot spare CGW antenna in response to the detection.

Additional or alternative steps in light of the disclosure herein are also contemplated.

FIG. 8 illustrates an example computer device that can be used in connection with any of the systems or components of the network switch 504, the network interface processor 506, the control processor 508, the backbone user terminal 106, the gateway terminal 104, the PoP 140, the satellite computer system 103, the user terminal 112, the ground-based server 150, or other components disclosed herein. In this example, FIG. 8 illustrates a computing system 800 including components in electrical communication with each other using a connection 805, such as a bus. System 800 includes a processing unit (CPU or processor) 810 and a system connection 805 that couples various system components including the system memory 815, such as read only memory (ROM) 820 and random access memory (RAM) 825, to the processor 810. The system 800 can include a cache of high-speed memory connected directly with, in close proximity to, or integrated as part of the processor 810. The system 800 can copy data from the memory 815 and/or the storage device 830 to the cache 812 for quick access by the processor 810. In this way, the cache can provide a performance boost that avoids processor 810 delays while waiting for data. These and other modules can control or be configured to control the processor 810 to perform various actions. Other system memory 815 may be available for use as well. The memory 815 can include multiple different types of memory with different performance characteristics. The processor 810 can include any general purpose processor and a hardware or software service, such as service 1—832, service 2—834, and service 3—836 stored in storage device 830, configured to control the processor 810 as well as a special-purpose processor where software instructions are incorporated into the actual processor design. The processor 810 may be a completely self-contained computing system, containing multiple cores or processors, a bus, memory controller, cache, etc. A multi-core processor may be symmetric or asymmetric.

To enable user interaction with the device 800, an input device 845 can represent any number of input mechanisms, such as a microphone for speech, a touch-sensitive screen for gesture or graphical input, keyboard, mouse, motion input, speech and so forth. An output device 835 can also be one or more of a number of output mechanisms known to those of skill in the art. In some instances, multimodal systems can enable a user to provide multiple types of input to communicate with the device 800. The communications interface 840 can generally govern and manage the user input and system output. There is no restriction on operating on any particular hardware arrangement and therefore the basic features here may easily be substituted for improved hardware or firmware arrangements as they are developed.

Storage device 830 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 825, read only memory (ROM) 820, and hybrids thereof.

The storage device 830 can include services 832, 834, 836 for controlling the processor 810. Other hardware or software modules are contemplated. The storage device 830 can be connected to the system connection 805. In one aspect, a hardware module that performs a particular function can include the software component stored in a computer-readable medium in connection with the necessary hardware components, such as the processor 810, connection 805, output device 835, and so forth, to carry out the function.

In some embodiments, computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can include, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can include hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language reciting “at least one of” refers to at least one of a set and indicates that one member of the set or multiple members of the set satisfy the claim. For example, claim language reciting “at least one of A and B” means A, B, or A and B.

1. A community gateway for a satellite communication system, wherein the satellite communication system includes a plurality of terrestrial gateway terminals and a plurality of satellites, wherein the terrestrial gateway terminals are in communication with the Internet, and wherein each of the satellites includes a satellite (SAT) gateway-wavelength antenna, the community gateway comprising:
a network switch configured to route data packets received from an Internet Service Provider (ISP); and
a plurality of community gateway (CGW) antennas, wherein each CGW antenna is configured to communicate with the SAT gateway-wavelength antenna via a CGW-SAT link, wherein each CGW antenna includes a network interface processor configured to route data packets between the network switch and the CGW antenna, and wherein:
the network interface processor includes a network interface processor memory storing instructions executable to cause the network interface processor to perform network interface steps including reporting to the network switch a connection status of a connection between the CGW antenna and a node of the satellite communication system, and
the network switch includes a network switch memory storing instructions executable to cause the network switch to perform network switch steps including routing the data packets to the CGW antennas for transmission through the satellite communication system based on the reported connection status of the CGW antennas.

2. The community gateway according to claim 1, wherein the satellite communication system includes a plurality of Points of Presence (PoPs) on the Internet connected to the terrestrial gateway terminals, and wherein the connection is between the CGW antenna and one of the PoPs.

3. The community gateway according to claim 2, wherein each of the satellites includes one or more laser communication terminals (LCTs), wherein the satellites are configured to establish SAT-SAT links using the one or more LCTs to form a satellite mesh topology within the satellite communication system, and wherein the connection between the CGW antenna and the one of the PoPs is established through the satellite mesh topology.

4. The community gateway according to claim 1, wherein the network interface steps further include:
executing a path failure detection protocol supported by the network switch; and
reporting the connection status to the network switch using the path failure detection protocol.

5. The community gateway according to claim 4, wherein the network switch steps further include executing a plurality of instances of the path failure detection protocol, wherein for each instance, the instance and the path failure detection protocol executing at the network interface processor of a corresponding one of the plurality of CGW antennas are peers in the path failure detection protocol.

6. The community gateway according to claim 5, wherein the path failure detection protocol defines session states and includes path failure detection protocol packets sent by each of the peers to the other of the peers, and wherein the path failure detection protocol packets include an indicator for a current session state as observed by the sending peer.

7. The community gateway according to claim 6, wherein the network interface steps further include:
initiating one or more network communication pathways to the node of the satellite communication system; and
receiving a response from the node including an indication that the one or more network communication pathways are successfully established, wherein the step of reporting the connection status includes reporting a positive connection status in response to the indication.

8. The community gateway according to claim 7, wherein the step of initiating the one or more network communication pathways includes initiating one or more tunnels of a virtual private network (VPN) implemented over the satellite communication system.

9. The community gateway according to claim 7, wherein the step of initiating the one or more network communication pathways is performed at a first time in response to topology schedule data indicating that the corresponding CGW antenna is scheduled to communicate user data over a new CGW-SAT link beginning at a second time.

10. The community gateway according to claim 7, wherein the step of reporting the positive connection status includes:
making, by an executive module of the network interface processor in response to the step of receiving the response from the node, an enablement call to the path failure detection protocol executing at the network interface processor; and
in response to the enablement call, sending the path failure detection protocol packets from the path failure detection protocol executing at the network interface processor to the path failure detection protocol executing at the network switch, wherein the session state reported in one or more of the path failure detection protocol packets serves as the report of the positive connection status.

11. The community gateway according to claim 10, wherein the step of reporting the positive connection status further includes utilizing a polling functionality of the path failure detection protocol in the one or more path failure detection protocol packets.

12. The community gateway according to claim 7, wherein the network interface steps further include, subsequent to reporting the positive connection status:
receiving return data packets routed from the node of the satellite communication system and addressed to an address associated with the ISP; and
forwarding the return data packets to the ISP through the network switch.

13. The community gateway according to claim 7, wherein the network interface steps further include closing the one or more network communication pathways to the node of the satellite communication system at a third time in response to topology schedule data indicating that the corresponding CGW antenna is scheduled to break a current CGW-SAT link at a fourth time.

14. The community gateway according to claim 13, wherein the network interface steps further include, in association with the step of closing the one or more network communication pathways, reporting the connection status as negative to the network switch, and wherein the network switch step of routing the data packets to the CGW antennas for transmission through the satellite communication system includes, in response to the report of the negative connection status, ceasing to route the data packets received from the ISP through the network interface processor.

15. The community gateway according to claim 14, wherein the step of reporting the negative connection status includes:
making, by an executive module of the network interface processor in association with the step of closing the one or more network communication pathways, a disablement call to the path failure detection protocol executing at the network interface processor; and
in response to the disablement call, sending the path failure detection protocol packets from the path failure detection protocol executing at the network interface processor to the path failure detection protocol executing at the network switch, wherein the session state reported in one or more of the path failure detection protocol packets serves as the report of the negative connection status.

16. The community gateway according to claim 15, wherein the step of reporting the negative connection status further includes utilizing a polling functionality of the path failure detection protocol in the one or more path failure detection protocol packets.

17. The community gateway according to claim 1, wherein each of the satellites further includes a satellite (SAT) phased array antenna, and wherein the community gateway further comprises a backbone user terminal (BUT) configured to communicate with the SAT phased array antenna via a BUT-SAT link.

18. The community gateway according to claim 17, wherein the backbone user terminal is further configured to:
in association with initialization of the community gateway, perform a sky search to acquire the BUT-SAT link; and
obtain, via the BUT-SAT link, topology schedule data specifying the CGW-SAT links to be made by the CGW antennas for a plurality of future time slots.

19. The community gateway according to claim 18, wherein the satellite communication system further includes a satellite operations (SatOps) services platform, and wherein the backbone user terminal is further configured to maintain an operational connection to the SatOps services platform after the initialization.

20. The community gateway according to claim 1, further comprising a hot spare CGW antenna in addition to the plurality of CGW antennas and a control processor configured to enable configuration, monitoring, and control of the plurality of CGW antennas and the hot spare CGW antenna, wherein the control processor includes a control processor memory storing instructions that are executable to cause the control processor to perform steps including:
detecting that a performance of any one of the plurality of CGW antennas has dropped below an acceptable level; and
switching the CGW-SAT links and network routing responsibilities of the any one of the plurality of CGW antennas to the hot spare CGW antenna in response to the detection.

21-40. (canceled)
